(19) United States
(12) Patent Application Publication
(10) Pub. No.: US 2006/0019567 A1
(43) Pub. Date: Jan. 26, 2006

(54) Manufacture of papermachine fabrics

(75) Inventor: Ian Sayers, Lancashire (GB)

Correspondence Address: GREENBLUM & BERNSTEIN, P.L.C., 1950 ROLAND CLARKE PLACE, RESTON, VA, 20191, US

(73) Assignee: Voith Fabrics Patent GmbH, Heidenheim (DE)

(21) Appl. No.: 11/184,891

(22) Filed: Jul. 20, 2005

(30) Foreign Application Priority Data
Jul. 21, 2004 (DE) 10 2004 035.369.7

(51) Int. Cl. B32B 5/08

(52) U.S. Cl. 442/218

(57) ABSTRACT

Paper machine clothing method including covering an extended working surface with successive layers of a resultant material. Treating each successive layer with an energy source in accordance with predetermined instructions before adding a next successive layer to build up a three-dimensional fabric structure. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 10 2004 035 369.7, filed on Jul. 21, 2004, the disclosure of which is expressly incorporated by reference herein in its entirety.

### BACKGROUND OF THE INVENTION

1. Field of the Invention

The invention relates to the manufacture of papermachine fabrics such as forming fabrics, press felts, dryer fabrics, through-air dryer (TAD) fabrics and other industrial fabrics, such as hydroentanglement screens and transfer fabrics for use in a papermachine.

2. Discussion of Background Information

Paper is conventionally manufactured by conveying a paper furnish, usually composed of an initial slurry of cellulosic fibers, on a forming fabric or between two forming fabrics in a forming section, the nascent sheet then being passed through a pressing section and ultimately through a drying section of a papermaking machine. In the case of standard tissue paper machines, the paper web is transferred from the press fabric to a Yankee dryer cylinder and then creped, or alternatively on more modern machines a monofilament woven mesh dryer fabric conveys the web from the forming fabric to a through-air dryer, followed by a Yankee cylinder.

Papermachine clothing is essentially employed to carry the paper web through these various stages of the papermaking machine and to facilitate water removal from the sheet in a controlled manner. In the forming section the fibrous furnish is wet-laid onto a moving forming wire and water is encouraged to drain from it by way of suction boxes and foils. The paper web is then transferred to a press fabric that conveys it through the pressing section, where it is usually passed through a series of pressure nips formed by rotating cylindrical press rolls. Water is squeezed from the paper web and into the press fabric as the web and fabric pass through the nip together. In the final stage, the paper web is transferred either to a Yankee dryer, in the case of tissue paper manufacture, or to a set of dryer cylinders upon which, aided by the clamping action of the dryer fabric, the majority of the remaining water is evaporated.

Papermachine fabrics traditionally consist of a woven fabric. As the warp and weft yarns interweave, a so-called “knuckle” is formed as they cross. These knuckles have a tendency to mark the paper sheet formed on the fabric. This problem is particularly apparent at the wet end of the papermachine where the sheet is still highly plastic. In recent years, various methods have been suggested for making nonwoven papermachine fabrics in order to eradicate the problem associated with knuckle marking, particularly for press and dryer section applications. Many of these have been impractical to manufacture commercially.

GB 1,053,954 describes a nonwoven papermakers' fabric comprising two layers of parallel polymeric filaments, the layers being attached together in such a manner that the filaments of one layer are disposed at an angle with respect to the filaments in another layer. Such an arrangement is not durable and consequently this fabric is not commercially viable.

U.S. Pat. No. 3,617,442 describes a forming fabric comprising a sheet of synthetic, open-celled, flexible foam such as polyurethane. This is reinforced by a series of polyester cables, a coarse wire screen or a thin flexible metal or plastic sheet. Such an arrangement, if ever commercialized, would exhibit poor wear resistance.

GB 2,051,154 relates to a so-called “link belt” in which a base fabric is formed from a series of interdigitated helices joined together by pintle wires. Link belts are only suitable for certain applications, due to calliper and material restrictions.

U.S. Pat. No. 4,541,895 describes a papermakers' fabric made up of a plurality of nonwoven sheets laminated together to define a fabric or belt. The nonwoven sheets are perforated by laser drilling. Such sheets are composed of unoriented polymer material, and if produced in the fineness needed for papermaking applications, would lack sufficient dimensional stability to operate as endless belts on papermachines.

The subject invention of GB 2,235,705 describes a base fabric for press felts. Here an array of sheath core yarns of which the core has a higher melting point than the sheath, is fed in spaced parallel disposition to peripheral grooves of a press roller arranged in nip-forming relationship with a press roll. The material of the sheath is melted as the yarns move into and through the roller nip and excess melted sheath material is forced into lateral and vacant circumferential grooves in the roller to form structural members between adjacent yarns. A wide belt may be formed by joining similar strips together. A batt of fibers is subsequently needled to the base fabric so as to form a press felt. Perforations through the mesh-like base fabric extend straight through the fabric. This is undesirable for adaptation to paper sheet formation, where controlled dewatering is required, especially during the delicate sheet forming phase.

GB 2,241,915 relates to a method of producing a papermaking fabric in which a layer of photopolymeric resin is applied to a moving band. A moving, selectively transparent, mask is positioned above the resin and the resin is irradiated through the mask to effect an at least partial cure of the parts of the resin layer in register with the transparent regions of the mask. After irradiation uncured regions of the resin are removed by pressure fluid jets and final curing of the resin is effected either thermally or by way of flooding actinic radiation. The foraminous sheet so formed may be reinforced with yarns or fibers. Once again holes extend straight through the fabric. This is undesirable for paper sheet formation and additionally permits the occurrence of harmful “backwash” which comes from hydraulic pulses passing through the fabric from the machine side. The direct passage of these pulses disturbs the fragile cellulosic fibrous network.

GB 2,283,991 relates to papermachine clothing made from partially fused particles. A reinforcing structure is embedded within the structure. This papermachine clothing is suitable for pressing applications and possibly special forming applications.

The processes used in the method of manufacture of papermachine fabrics is based on stereolithography wherein a three dimensional object is fabricated by the action of a laser on a radiation curable polymer. The object is built up layer by layer on a support which is gradually lowered after each scan of the laser into a bath of the polymer, as successive layers are built up at the surface of the polymer. The laser is controlled by a CAD program stored on an STL file which guides the movements of the laser to produce the appropriate shape for each layer. Selective laser sintering is a closely related process which may be also categorized as a stereolithographic process, wherein powdered thermoplastic is gradually built up in a build cylinder, with each layer being selectively sintered by thermoplastic fusion to build up the three dimensional object, by way of an IR laser. U.S. Pat. No. 4,575,330 describes the essentials of this process.

The process of modeling a three dimensional object by selective laser sintering, that is using laser energy to sinter selected parts of a succession of layers of sinterable particulate material, such as thermoplastics, is outlined in for example the introductory parts of WO 92/08567 and WO 93/08928.

Neither process has been applied to extended planar products, and seems to be used to date solely for prototyping and providing masters for casting or moulding. The present invention is concerned with the necessary adaptation of these processes for producing articles with extensive surface area but relatively small thickness, such as papermachine fabrics.

### SUMMARY OF THE INVENTION

The present invention provides a method of manufacturing a non-woven papermachine fabric and which adopts techniques of this kind to the manufacture of planar articles.

According to the invention, the method of manufacturing a papermachine fabric includes providing an extended working surface, covering the working surface with successive layers of the resultant material, and treating each successive layer in turn with an energy source in accordance with predetermined instructions before addition of the next successive layer, to build up a three dimensional fabric structure.

The treatment of each layer is preferably carried out selectively, that is some parts of the layer will be treated whilst others remain untreated.

The energy source may comprise one or more devices such as lasers for producing concentrated beams or pencils of radiation, such for example as UV or IR.

The plastics material may comprise a UV-curable resin, in which case the energy source can comprise one or more UV lasers. Such resins are usually cured from liquid state, and appropriate containment apparatus may be required, for example the working surface may be located in a trough or bath containing the liquid resin or provided with boundary fences. To prevent or hinder oxidation, the volume enclosed by the fences may contain an inert atmosphere such as CO₂. The successive layers may be provided by raising dispensing apparatus and parts of the containment apparatus after each treatment stage by a height equal to the required layer thickness. Use of a spreader may be required to compensate for deviations of the working surface from a true plane, which may be of the same order as the layer thickness. If the resin is applied in each layer as a fluid film, constrained by surface tension complex containment such as dams may not be required, or precise leveling. The UV-crosslinkable resin may comprise an acrylated epoxy product.

Alternatively, the plastics material may comprise a particulate thermoplastic material which can be fused or melted by being subjected to heating such as PPS, PEEK, polyolefin or polyamide. In this case the energy source can comprise one or more IR lasers. The thermoplastic material is preferably provided in a dry finely divided form, such as microspheres or sub millimeter particles, such as a molding powder. Containment of the material, and absolute planarity of the work surface are not as much of a problem as when liquid resins are used, but ensuring that each layer is evenly spread may require provision of special spreading apparatus, capable of ensuring an even powder layer over an extensive area of several square meters.

The apparatus is preferably arranged so that there is relative vertical movement between the laser and the working surface in the case of a thermoplastic material treatment stage by a distance equal to the required layer thickness to receive the next layer of particulate or powdered thermoplastic material. Typically each layer may have a thickness of about 0.1 mm, and a finished fabric of a total depth of up to 2 mm.

Treatment of the plastics material layer may respectively cause crosslinking of a liquid UV curable resin in the parts selected to be exposed to UV laser(s)—e.g. tuned to 365 mm, or fusion or sintering of a thermoplastic material in the parts selected to be exposed to the IR laser(s)—e.g. CO₂ lasers operating at 50-200 W. Un-cured or un-fused material may, after completion of the layered structure be removed by drainage or flushing out, or in the case of fine particles blown or drawn out by an air blast or suction device. The laser beams may be concentrated to produce a point resolution of say 0.01-0.1 mm.

Removal of the untreated plastics material leaves the desired article on the working surface.

The extended working surface is required to be large enough to allow formation of full size paper machine fabrics, which can measure up to 11 m by 30 m. The work surface may comprise an endless belt, preferably coated with a non-stick PTFE coating and having a width equal to or somewhat greater than the papermachine fabric to be fabricated. The fabric may be built up in zones extending across the width of the belt, with each zone being integrated by the deposition and treatment process with the previous zone, repeating the layer by layer building up in each zone in turn to form a fabric of any desired length. The fabric may be peeled off from the endless belt and taken up for later seaming, or the seaming problem avoided by forming the fabric as an endless belt of similar dimensions to the working surface belt, and removing it from the working surface belt.

The energy source may comprise a single UV or IR laser, or an array of such lasers either ganged to be operated together, or independently operated and controlled.

The lasers whether single, multiple, ganged or independent, are preferably controlled with respect to their operations (e.g., fire, don't fire) and movement (e.g., left/right, forwards/backwards, up/down) by a control apparatus which preferably includes a computer incorporating or connected to a CAD system in which is pre-programmed a representation of the section of the fabric being reproduced by the method according to the invention.

Reinforcing yarns may be laid down, either in or across the belt direction during application of the layers on the work surface.

The method of manufacture according to the invention, provides the possibility to produce non-woven papermachine fabrics according to almost any traditional or innovative design, or to produce non-woven webs for use as components in composite fabrics, for example as base layers in press felts.

Another aspect of the invention provides an apparatus for use in manufacture of papermachine fabrics comprising: an extended working surface, a device to cover the working surface with successive layers of a plastics material, an energy source for treating each successive layer in turn, and device to control the energy source in accordance with predetermined instructions.

The extended working surface may comprise an endless belt, and the device to cover the surface with successive layers of a plastics material may include a device to feed and spread the material in liquid or particulate form on the surface.

The energy source preferably comprises one or more UV or IR lasers, the projectors of which are mounted for movement relative to the working surface on all three axes. A UV laser will normally be used in connection with UV-curable resins in liquid form, and an IR CO₂ laser in conjunction with thermoplastic material applied in particulate or powder form.

The control device may include a device to move the laser projectors on all three axes, that is the two horizontal axes and towards and away from the working surface, controlled by a computer programmed with a CAD program including instructions for movements of the laser head required and sequence of discharging or not discharging the laser.

The invention is directed to the method of a papermachine clothing including covering an extended working surface with successive layers of a resultant material. The step of treating each successive layer with an energy source in accordance with predetermined instructions before adding a next successive layer to build up a three-dimensional fabric structure.

According to another feature of the invention the method includes treating successive layers selectively, since that portions of each layer include a treated portion and an untreated portion. Further, the energy source produces optical radiation. Further still, the energy source comprises one of a UV laser and IR laser. The energy source may also comprise at least one IR laser.

According to another feature of the invention the method includes the resultant material used is a plastic material. Further, the plastic material may comprise of a UV-curable resin. Further still, the UV-curable resin can be a UV-crosslinkable resin. The UV-curable resin may comprises of an acrylated epoxy product. Further, the UV-curable resin can be cured from a liquid state. Further still, the plastic material is at least partially processed in an inert atmosphere. The plastic material may comprise of a particulate thermoplastic material. Further, the plastic material may comprise of at least one of PPS, PEEK, polyolefin and polyamide.

According to another feature of the invention the method includes the thermoplastic material may be presented in a dry and distributed form. Further, the thermoplastic material can be formed as one of an microspheres and submillimeter particles.

According to another feature of the invention the method includes during the application of the layers to the working surface, the method further includes arranging, reinforcing yarns either transversely, not transversely or at least partially transverse with respect to the intended machine direction of the paper machine fabric.

According to another feature of the invention an apparatus includes at least one extended working surface and at least one dispensing head arranged for movement over and for dispensing a material onto the at least one extended surface. Further, at least one energy source mounted for movement over the at least one extended working surface. Further still, a control device coupled to the at least one energy source to selectively treat and not treat portions of the dispensed material with the energy source.

According to another feature of the invention at least one dispensing head can be structured and arranged to dispense successive layers of material. Further, the control device can be structured and arranged to treat and not treat portions of each successive layer with the energy source before a next successive layer is added.

According to another feature of the invention a fabrication zone extends across the width of a upper pass and in a running direction of the extended working surface, such that the fabrication zone is boarded by one or more walls. Further, at least two of the side walls each are arranged at an edge of the extended working surface, such that at least two of the walls are adjustable in height. Further still, a front wall facing the running direction of the extended working surface, such that the front wall is slidably engagable with the extended working surface. Also, an adjustable rear wall can be adjustable over the material arranged on the extended working surface. Further, the material is passed through at least one purging station and at least one curing station after exiting the extended working surface.

In accordance with another feature of the invention, each successive layer is above 0.1 thickness, such that the material is approximate 2.0 mm in thickness or about 20 successive layers.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a diagrammatic side view of apparatus for carrying out methods of manufacturing a papermachine fabric according to the invention;

FIG. 2 is an enlarged fragmentary view of a part of the FIG. 1 apparatus;

FIG. 3 is a perspective view of the apparatus of FIG. 1;

FIG. 4 is an enlarged fragmentary view showing a step in the making of a fabric by a first method according to the invention;

FIG. 5 is a view similar to FIG. 4 showing a step making a fabric by a second method according to the invention;

FIG. 6 is a sectional view of a membrane type fabric with tapered perforations produced by a method according to the invention;

FIG. 7 is a sectional view of a second perforated membrane type fabric including reinforcing yarns embedded in the membrane, also produced by a method according to the invention;

FIG. 8 is a fragmentary view of a joining zone in a seaming procedure for the fabric; and

FIG. 9 is a sectional view of the joining zone of FIG. 8.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

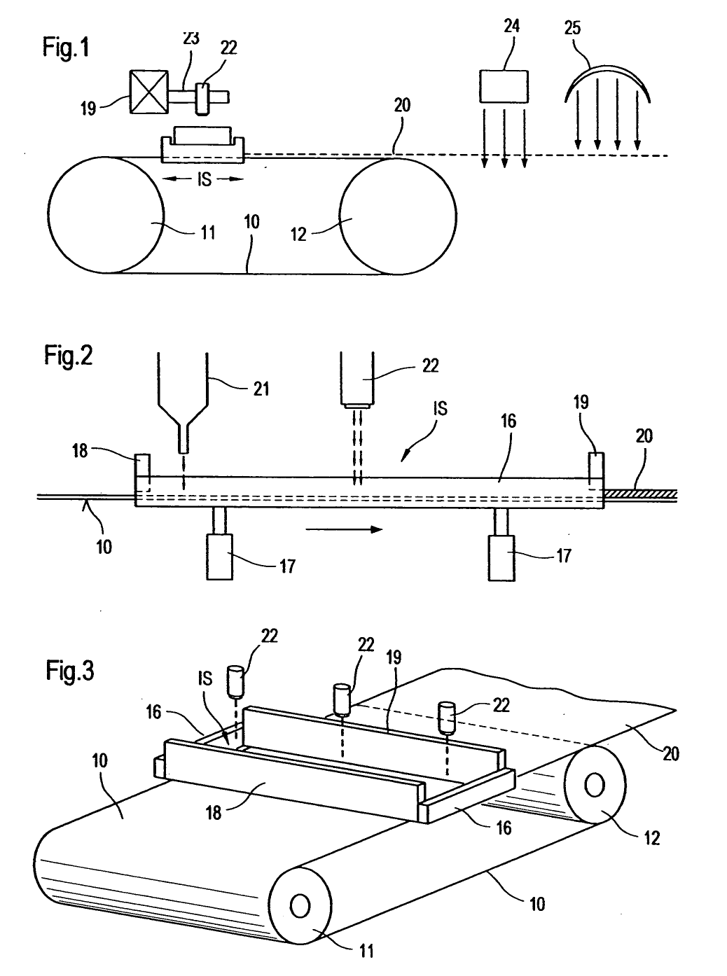

FIGS. 1, 2 and 3 illustrate an embodiment of apparatus which may be used in a method according to the invention for the manufacture of papermachine fabrics, either by use of a UV-curable resin, or by sintering of a particulate thermoplastic material.

The apparatus comprises an endless belt 10 provided on terminal rollers 11, 12. Other guide, drive, and support rollers are omitted for the sake of simplicity. The belt 10 is coated with a fluoropolymer material to provide an easy release surface and forms an extended working surface for the fabrication of papermachine fabrics. A fabrication zone 15 is provided which extends across the width of the upper pass of the belt 10, and in the running direction of the belt 10, for a relatively short distance. The zone 15 is bordered by containment walls or fences, which take the form of side walls 16 at the edges of the belt, mounted on pistons 17 for height adjustment, a front wall 18 facing the direction of approach of the belt 10, which is in sliding engagement with the surface of the belt, and a rear wall 19 which can be raised to a clearance above the belt 10 to allow a formed fabric 20 to leave entrained by the belt, on the belt surface.

The fabric 20 is taken off from the belt 10 and subjected to further processing.

The fabric is formed of successive layers of for example above 0.1 mm thickness, built up to a fabric thickness of for example 2 mm, thus typically entailing the successive application of about 20 layers of material.

The drawings are thus not to scale as the walls 16, 18 and 19 may be no more than 10 mm in height, whilst the width of the belt may for example be about 11 meters, and the lengthwise extent (relative to the belt) of the zone 15 may be in the order of 100 mm.

The material is dispensed into the zone by a multiple dispensing head 21 (not shown in FIGS. 1 or 3) in the form either of a liquid UV-curable resin, or a finely divided particulate or powdered thermoplastic material to form a succession of even layers thereof about 0.1 mm in depth. A doctor blade or spreader (not shown) may be used.

If a spreader to spread resin is used, this may aid molecular orientation in a preferred direction. Support material may not be required to support overhangs where an upper layer is not directly supported by material beneath it, but instead overlies a void, if the modulus of the cured resin is such as to be self-supporting at the scale concerned, so that such unsupported material does not sag into the void below. Where the inherent stiffness of the cured resin material is insufficient to ensure such self-support at the scale concerned, some form of “scaffolding” has to be provided, in the form of sacrificial material which fills the voids for later removal after full crosslinking and curing of the resin.

The material is treated by an array of lasers 22, which in the case of liquid UV-curable resin, are UV lasers operating at a wavelength of e.g. 365 nm, and these are mounted on a carriage 23, to be moved transversely of the belt 10, or back and forth in the direction of movement of the belt, and also up and down, with respect to the belt. This latter movement entails raising the lasers 22 by one layer thickness on completion of treating each successive layer, and then returning the lasers to their lowest elevation for the next section of fabric once the conveyor belt has moved the fabric to the right by the width of the zone 15. These movements and operation of the lasers are controlled by a computer 19 running a CAD program. In the case of the use of thermoplastic powder or particles, the lasers 22 are IR lasers operating at a power output in the range of 50-200 W which heat the particles to a temperature sufficient to at least soften the surfaces of the particles enough to enable the particles to fuse on their contact zones. The particles used are in the order of 50 microns in diameter. A pressure roller not shown can be used to tamp the powder to a uniform level, which also aids fusion bonding of the particles. Normally, in sintering thermoplastics, the fabrication chamber is kept at a temperature just below the melting point of the powder, so that the laser only has to input a minimal amount of extra energy to effect fusion. Also the operation has to be carried out in an inert N₂ or CO₂ atmosphere to prevent oxidation which can involve containment problems.

The lasers 22 are selectively operated to provide cured/fused and uncured/infused areas on the layer, the fused/cured areas remaining as part of the fabric structure and the uncured/uncured areas being removed after setting of the resin or thermoplastic to provide voids, perforations or pores in the fabric structure.

When the fabric 20 is taken off the belt 10, it is passed through a purging station 24 where uncured or infused material is removed from the fabric 20, leaving voids or pores in the cured or fused fabric structure. This purging may be effected by water or other solvent or washing liquid, especially in the case of UV-curable resin, or an air blast or suction in the case of particulate materials.

After the purging station, the remaining belt material is subjected, in the case of UV-curing resin, to a general bath of UV radiation, to ensure complete curing, at a curing station 25. In the case of thermoplastic particles this may be exchanged for a cooling station using refrigerated air to ensure setting of the thermoplastic material.

The UV-curable resin may comprise a formulation which includes an initiator which is activated by absorption of UV radiation.

The particulate thermoplastic material may be in the form of a powder such as a moulding powder or thermoplastics microspheres, and of any suitable thermoplastic material such as polyolefin, PEEK, polyester polyamide or the like.

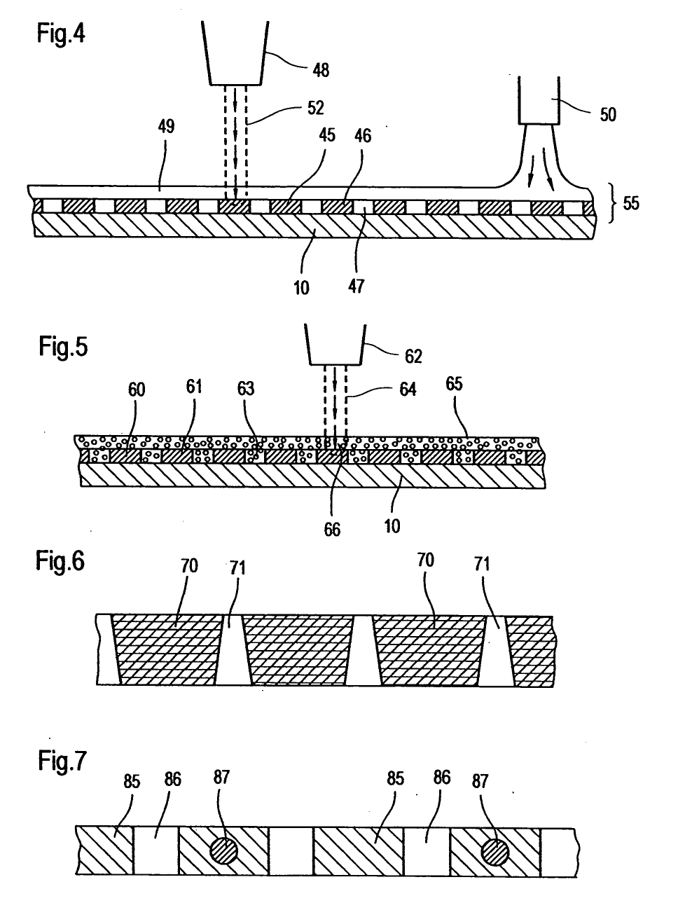

FIG. 4 illustrates as a simple case fabrication of a perforated membrane from a UV-curable resin. A first layer 45 of resin has been laid and selectively cured using a laser 48. Cured areas 46 are shown cross-hatched in the drawing, and these provide the lands of the membrane. Uncured areas 47 are shown unhatched, and these will form the apertures through the membrane when completed and the uncured resin 47 removed by purging. A second layer 49 is just being completed by supply of a further film of liquid uncured resin from the nozzles 50 of the distributor head. A laser projector 48 emits a beam 52 of UV radiation which affects the upper, in this case, second layer 49, the UV radiation initiating curing of the resin in the second layer in the zones where the laser is operated as it is scanned. There is some overlap of the depth to which radiation penetrates into the first layer 45, and also into the edge region of the previous strip to ensure bonding between successive layers.

FIG. 5 shows fabrication of a simple structure, again a perforated membrane in the process of manufacture using sintering of thermoplastic particles. A lower particle layer 60 has already been treated, with hatched zones 61 fused by a laser 62, and unhatched zones 63 left infused; these will form the perforations in the membrane after removal of infused particles. Laser pencil 64 is beginning to treat a second newly spread layer 65 of infused thermoplastic particles, with fusion occurring in the zone 66 directly affected by the laser pencil 64, which penetrates into the upper part of the already treated lower layer 60, re-softening this and ensuring bonding between the layers. “Arches” where material in an upper layer overlies a void in a lower layer are supported by infused material which is removed later.

FIGS. 6 and 7 show diagrammatically two relatively simple structures which may be formed by the methods illustrated in FIGS. 1, 2 and 3. Other more complex structures are of course possible.

FIG. 6 shows a membrane comprising lands 70 and apertures 71, the lands 70 comprising superimposed layers, and the apertures 71 being arranged to narrow upwardly towards the paper supporting (upper) side of the membrane. Such tapered apertures may be desirable for use in dewatering felts for example, but are not easy to make by other methods requiring molds including a bed of tapered pins which are costly to machine.

FIG. 7 shows a section of a further membrane comprising lands 85 and apertures 86, the latter being conventionally square, rectangular or circular in shape. Reinforcing yarns 87 are incorporated in the lands 85, having been laid down on the belt lengthwise (machine direction) during building up the structure by one of the methods described. Alternatively the reinforcing yarns could be laid transversely of the belt in the zone 15 before fabricating each strip.

A further possibility (not illustrated) is that a fabric could be created and manufactured using both the UV-curable resin and sintered particle processes in turn, e.g. a membrane or mesh can be made from a UV-cured resin, and then a sintered structure of thermoplastic material built up on top of the mesh or membrane.

The papermachine fabric structures which can be created using the method of the invention can mimic the properties of existing simple or complex structures, or new structures may be created. One structure which may be advantageous comprises a porous membrane with randomly distributed and dimensioned through pores, with integral support lands on the machine side having reinforcing yarns in the machine direction. The lands may be in the form of a net or mesh, or formed as machine direction ribs on the machine side of the membrane.

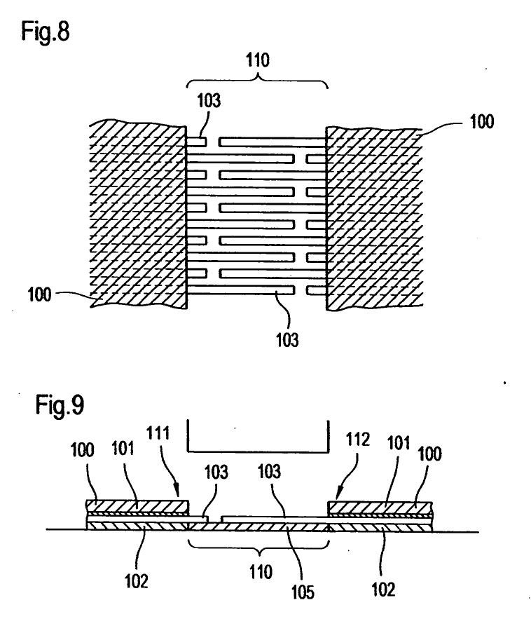

The belt 10 in the above embodiments may be coated with a release agent which allows the papermachine fabric created by the process according to the invention to be taken off the belt, after which it would be cleansed and rolled up. This process would continue until a length had been produced to fit a given designed fabric length. Conversion of the flat fabric into a continuous loop would be carried out as a separate step for example as illustrated in FIGS. 8 and 9.

In the embodiment of fabric 100 shown in FIGS. 8 and 9, the fabric comprises an upper porous membrane 101 having a multitude of randomly distributed pores, and a similarly porous lower stratum including lands 102 extending in the machine direction of the belt, within which reinforcing yarns 103 extend in the machine direction. The fabric 100 is disposed with a gap between the ends 111, 112 of the fabric, which constitutes a forming zone 110 in which a preliminary layer 105 is built up by a series of operations laying down successive layers of crosslinked or sintered material to match the thickness of material below the yarns 103. The yarns 103 projecting from the ends 111, 112 of the fabric are then laid over the layer 105, and a fabric structure matching the fabric 100 is then built around and over the yarns 103, by laying down further layers of crosslinked or sintered material, embedding the yarns and joining the ends of the fabric which matches the structure surface finish and porosity of the fabric 100 to complete the same as an endless fabric. The deposition and crosslinking/fusing apparatus are shown schematically as a box 120 in FIG. 9.

It will be noted that the yarns 103 at each end of the fabric 100 are cut alternatively long and short so that they can be interdigitated as shown in FIG. 8 to as far as possible avoid a pronounced line of weakness. Whilst shown in the drawings as straight, it is to be understood that the yarns 103 may be mechanically crimped in the joining zone between the ends 111 and 112. This will reduce risk of yarn/matrix slippage as crimped yarns resist being pulled from the matrix better than straight yarns. The joining may be effected before installation, or on the papermachine using a transportable apparatus.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A method of manufacturing papermachine clothing comprising:
covering an extended working surface with successive layers of a resultant material; and
treating each successive layer with an energy source in accordance with predetermined instructions before adding a next successive layer to build up a three-dimensional fabric structure.

2. The method as claimed in claim 1, wherein the treating of successive layers is carried out selectively, since that portions of each layer include a treated portion and an untreated portion.

3. The method as claimed in claim 1, wherein the energy source produces optical radiation.

4. The method as claimed in claim 3, wherein the energy source comprises one of a UV laser and IR laser.

5. The method as claimed in claim 4, wherein the energy source comprises at least one IR laser.

6. The method as claimed in claim 1, wherein the resultant material used is a plastic material.

7. The method as claimed in claim 6, wherein the plastic material comprises a UV-curable resin.

8. The method as claimed in claim 7, wherein the UV-curable resin is a UV-crosslinkable resin.

9. The method as claimed in claim 7, wherein the UV-curable resin comprises an acrylated epoxy product.

10. The method as claimed in claim 7, wherein the UV-curable resin is cured from a liquid state.

11. The method as claimed in claim 6, wherein the plastic material is at least partially processed in an inert atmosphere.

12. The method as claimed in claim 6, wherein the plastic material comprises a particulate thermoplastic material.

13. The method as claimed in claim 12, wherein the plastic material comprises at least one of PPS, PEEK, polyolefin and polyamide.

14. The method as claimed in claim 12, wherein the thermoplastic material is presented in a dry and distributed form.

15. The method as claimed in claim 14, wherein the thermoplastic material is formed as one of an microspheres and submillimeter particles.

16. The method as claimed in claim 1, wherein during the application of the layers to the working surface the method further includes arranging, reinforcing yarns either transversely, not transversely or at least partially transverse with respect to the intended machine direction of the paper machine fabric.

17. An apparatus comprising:
at least one extended working surface;
at least one dispensing head structured and arranged for movement over and for dispensing a material onto the at least one extended surface;
at least one energy source mounted for movement over the at least one extended working surface;
a control device coupled to the at least one energy source to selectively treat and not treat portions of the dispensed material with the energy source.

18. The apparatus according to claim 17, wherein the at least one dispensing head is structured and arranged to dispense successive layers of material; and
the control device being structured and arranged to treat and not treat portions of each successive layer with the energy source before a next successive layer is added.

19. The apparatus according to claim 17, wherein a fabrication zone extends across the width of a upper pass and in a running direction of the extended working surface, such that the fabrication zone is boarded by one or more walls;
at least two of the side walls each are arranged at an edge of the extended working surface, such that at least two of the walls are adjustable in height;
a front wall facing the running direction of the extended working surface, such that the front wall is slidably engagable with the extended working surface;
an adjustable rear wall is adjustable over the material arranged on the extended working surface;
wherein the material is passed through at least one purging station and at least one curing station after exiting the extended working surface.

20. The apparatus according to claim 17, wherein each successive layer is above 0.1 thickness, such that the material is approximate 2.0 mm in thickness or about 20 successive layers.
